(19) United States
(12) Patent Application Publication
(10) Pub. No.: US 2015/0012306 A1
(43) Pub. Date: Jan. 8, 2015

(54) EFFICIENT RESALE OF UNUSED EVENT TICKETS

(71) Applicant: Cellco d/b/a Verizon Wireless, Arlington, VA (US)

(72) Inventor: John Michael Butterfield, Hoboken, NJ (US)

(21) Appl. No.: 13/936,989

(22) Filed: Jul. 8, 2013

(51) Int. Cl. G06Q 10/02

(52) U.S. Cl. CPC G06Q 10/02
USPC 705/5

(57) ABSTRACT

A server device may be configured to receive information regarding one or more tickets to an event. The information may indicate that the one or more tickets have been previously purchased, and may further indicate that the one or more tickets have not been used. The server device may determine, based on a status of the event, and further based on the information indicating that the one or more tickets have been previously purchased and have not been used, that the one or more tickets should be offered for resale; and may offer, based on the determining, the one or more tickets for resale.

### BACKGROUND

Sporting events, concerts, and other types of events may require the purchase of a ticket for entry to the event. Tickets are frequently purchased ahead of time. In some instances, a ticketholder may become unable to attend an event for which he or she has already purchased a ticket, and may not be able or willing to resell the ticket. Furthermore, an attendee of the event may wish to purchase upgrade his or her seat to another seat, which is unoccupied.

### BRIEF DESCRIPTION OF THE DRAWINGS

FIGS. 1A-1C, 2A, and 2B illustrate an overview of one or more example implementations described herein;

FIG. 3 illustrates an example environment in which systems and/or methods, described herein, may be implemented;

FIG. 4 illustrates example functional components of one or more of the devices shown in FIG. 3;

FIG. 5 illustrates an example process for reselling unsold and/or unoccupied seats;

FIGS. 6A-6D, 7A, and 7B illustrate example user interfaces associated with registering tickets with a ticket resale program, in accordance with some implementations;

FIG. 8 illustrates an example user interface that may be presented to a prospective purchaser of unsold and/or unoccupied seats; and

FIG. 9 illustrates example components of one or more devices, according to one or more implementations described herein.

### DETAILED DESCRIPTION OF PREFERRED EMBODIMENTS

The following detailed description refers to the accompanying drawings. The same reference numbers in different drawings may identify the same or similar elements.

Techniques described herein may allow for the resale of venue tickets that have been previously sold, but are unused. Such a situation may occur when, for example, a ticketholder is unable to attend an event. Normally, the tickets would go unused, and the corresponding seats would be empty for the duration of the event. Meanwhile, another ticketholder, who is attending the event, may notice the empty seats, but may have no way of legitimately occupying the empty seats. Furthermore, a non-ticketholder may wish to purchase the seat, but may not have any way of knowing about the empty seat. As described below, some implementations may communicate with ticket scanners to determine which seats are occupied.

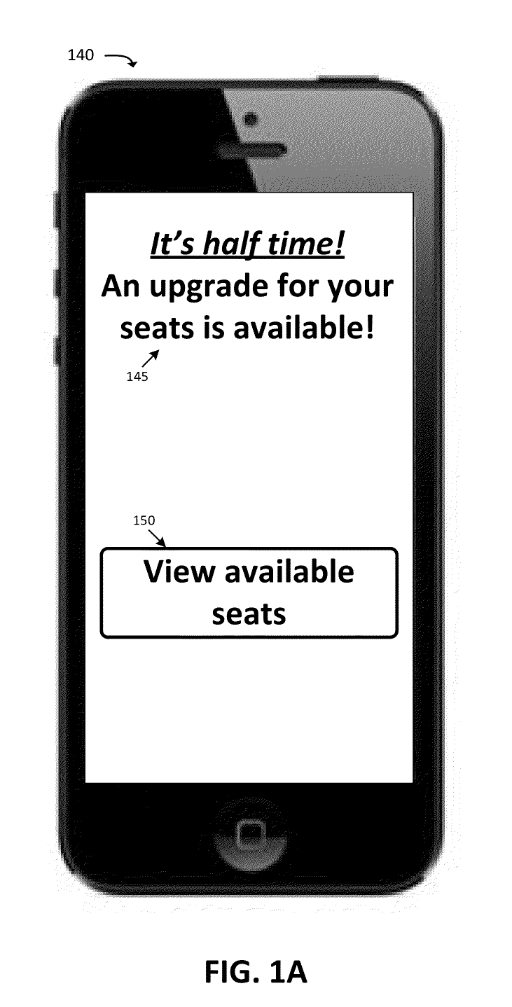

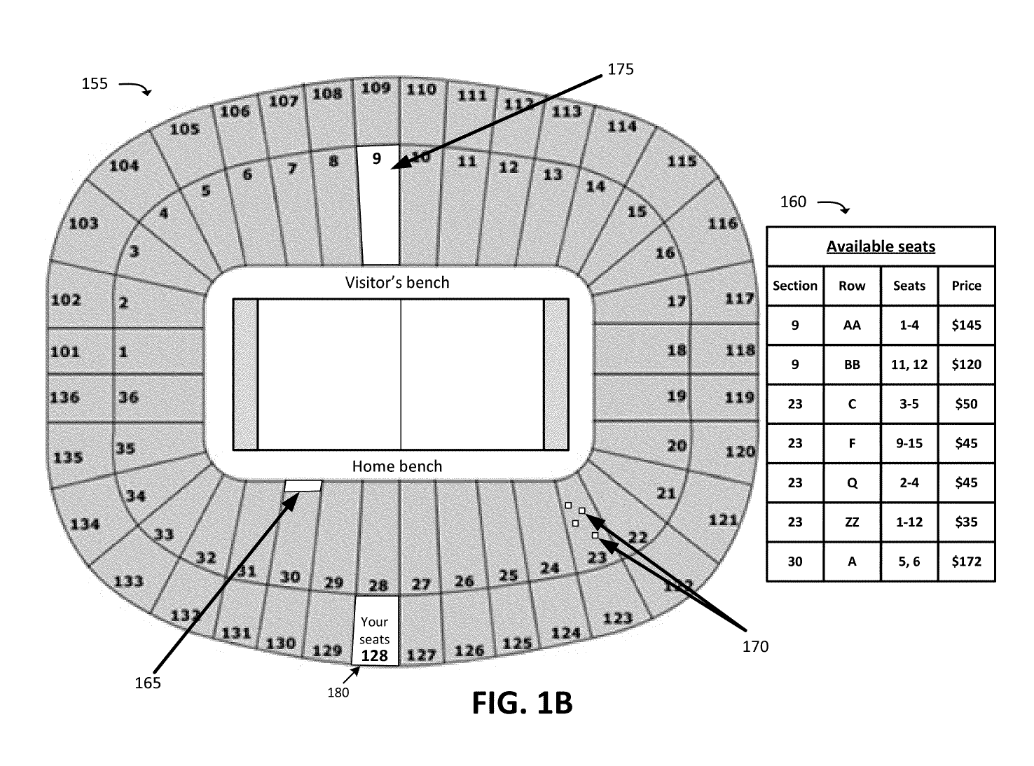

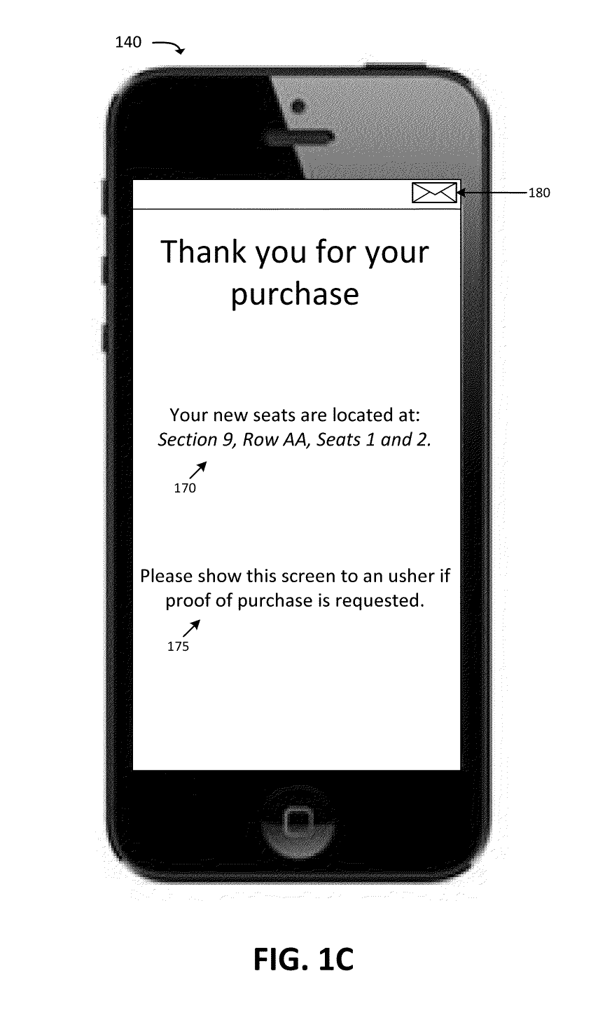

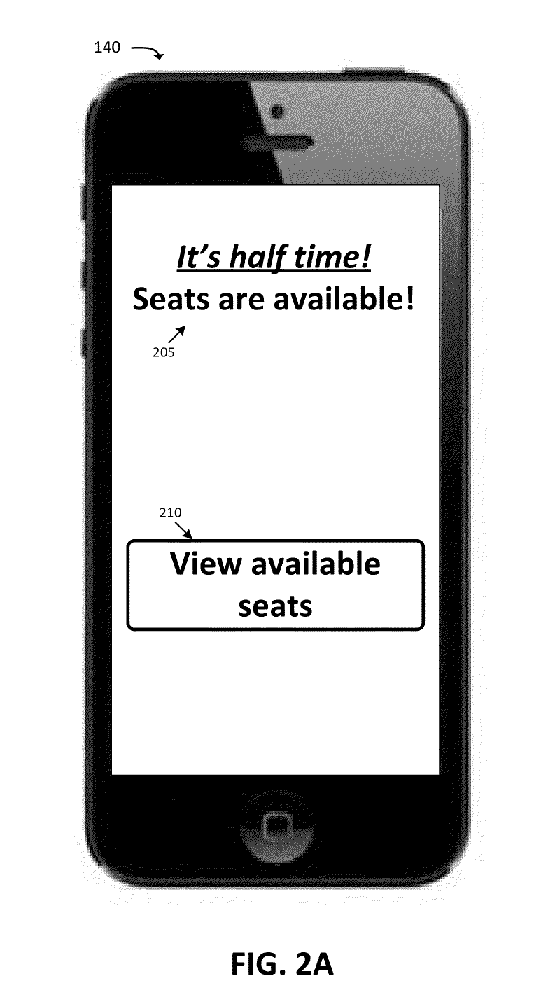

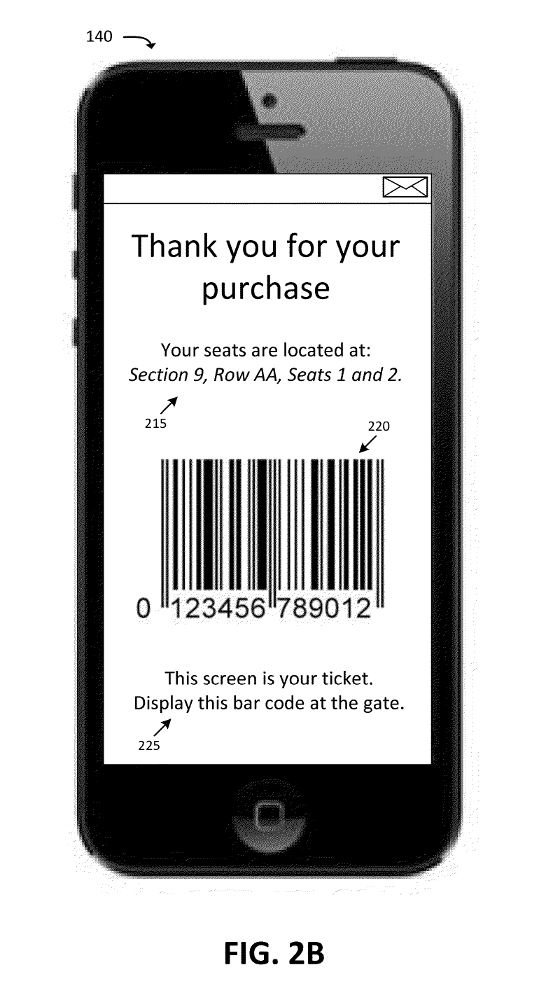

FIGS. 1A-1C, 2A, and 2B illustrate examples of how such unoccupied seats may be sold, thus resulting in the possibility of monetizing (or re-monetizing) seats that would otherwise be unused. FIG. 1A illustrates an example user interface that may be displayed on user device 140, which may be, for example, a smart phone associated with a user. Assume that the user of user device 140 is a ticketholder who is currently attending an event. Message 145 may be displayed (“It's half time! An upgrade for your seats is available!”) on user device 140. Message 145 may be delivered as, for example, a pop-up notification, an email, a text message, by an application associated with the venue or event, and/or via another delivery technique.

As described below, in some implementations, message 145 may only be displayed once a particular duration of time, or status, of an event has occurred. For instance, in some implementations, for sports games, message 145 may only be displayed after half time (e.g., when the game is approximately half over). In other words, resale of purchased, but unused tickets, may only begin at half time. By not allowing resale before a specific designated point in the event (e.g., half time), ticketholders may be afforded the opportunity of arriving reasonably late, without having their tickets resold.

Button 150 (“View available seats”) may also be displayed, allowing the user to view seats that are available, and potentially purchase new seats. FIG. 1B illustrates example graphical elements 155 and 160, which may be displayed on user device 140 when button 150 is selected. Graphical element 155 may include a visual representation of the venue (e.g., a seating chart). Graphical element 155 may further include visual representations 165-175 of available seats (e.g., seats that were previously purchased, but are unoccupied). Visual representations 165-175 may be shown as, for example, highlighted or differently shaded regions on graphical element 155. For instance, visual representation 165 may correspond to a row in which seats are available, visual representation 170 may indicate individual seats that are available, and visual representation 175 may indicate a section in which seats are available. Furthermore, graphical element 155 may include a visual indicator 180 of where the user's current seats are located, in order to provide the user with a frame of reference.

Graphical element 160, which may be displayed in addition to, or in lieu of, graphical element 155, may include a textual representation of available seats. For example, as shown, graphical element 160 may include a table that displays information regarding available seats. In some implementations, graphical elements 155 and 160 may be displayed simultaneously, while in other implementations, graphical elements 155 and 160 may be shown separately. Using these graphical representations, a user may select a seat to upgrade his or her existing seat.

FIG. 1C shows an example user interface that may be displayed by user device 140 after a ticketholder has upgraded his or her seats. For example, message 170 (“Your seats are located at: Section 9, Row AA, Seats 1 and 2”) may indicate information regarding the location of the new seats, while message 175 (“Please show this screen to an usher if proof of purchase is requested”) may remind the purchaser that the purchaser should use message 170 as proof of purchase of the upgraded seats. In some implementations, messages 170 and 175 may be delivered to the purchaser via, for example, email, as indicated by new email notification icon 180. In this manner, a user may be able to legitimately and economically “move down” to a better seat during an event.

FIGS. 2A and 2B illustrate another example implementation for reselling purchased, but unoccupied, seats. A situation may occur, for example, where a user, who is not a ticketholder for an event, wishes to attend the event. However, tickets may be sold out, or may be too expensive. As shown in FIGS. 2A and 2B, the user may be able to purchase tickets, at a discount, that were previously purchased, but remain unoccupied through the event.

For instance, as shown in FIG. 2A, message 205 (“It's half time! Seats are available!”) may be displayed by user device 140. Button 210 (“View available seats”) may also be displayed, which may allow the user to purchase tickets (e.g., using graphical elements similar to those shown in FIG. 1B). FIG. 2B illustrates example information, which may be displayed upon purchase of the tickets. As shown, message 215 (“Your seats are located at: Section 9, Row AA, Seats 1 and 2”) may indicate where the seats are located, bar code 220 may be used to enter the venue, and message 225 (“This screen is your ticket. Display this bar code at the gate”) may provide the user with instructions how to enter the venue.

In this manner, a user may be able to attend an event he or she would have otherwise not been able to attend. Furthermore, by offering a program in which users may purchase tickets that were previously sold, an event organizer may be able to offer additional events outside of the venue at which an event is held, and monetize these additional events. For instance, a football team may hold a tailgate party in a stadium of a parking lot, which is targeted at, or may attract, fans who do not have tickets to the game. Some of these fans may be fans who may desire to purchase tickets to the game itself, once the tickets become available. The football team may be able to monetize such a tailgate party by, for example, selling food, drinks, merchandise, relatively inexpensive tickets to the tailgate party, etc.

Furthermore, in some implementations, ticketholders may be provided with a portion of the proceeds, when their unused tickets are sold. Therefore, a benefit can be realized by all parties involved when unoccupied, but purchased, tickets are resold. The original purchaser may receive some of his or her money back when he or she does not use the tickets, the new purchaser may receive upgraded (or new) seats at a significant discount, and the venue and/or event organizer may realize additional monetary benefits (e.g., receiving additional payment for a ticket after having already received payment for the ticket, monetizing other events as described above, increasing goodwill of the venue, etc.). As described below, in some implementations, users may be provided with the opportunity to opt in to the ticket resale program, and in some implementations, users may be provided with the opportunity to opt out of the ticket resale program.

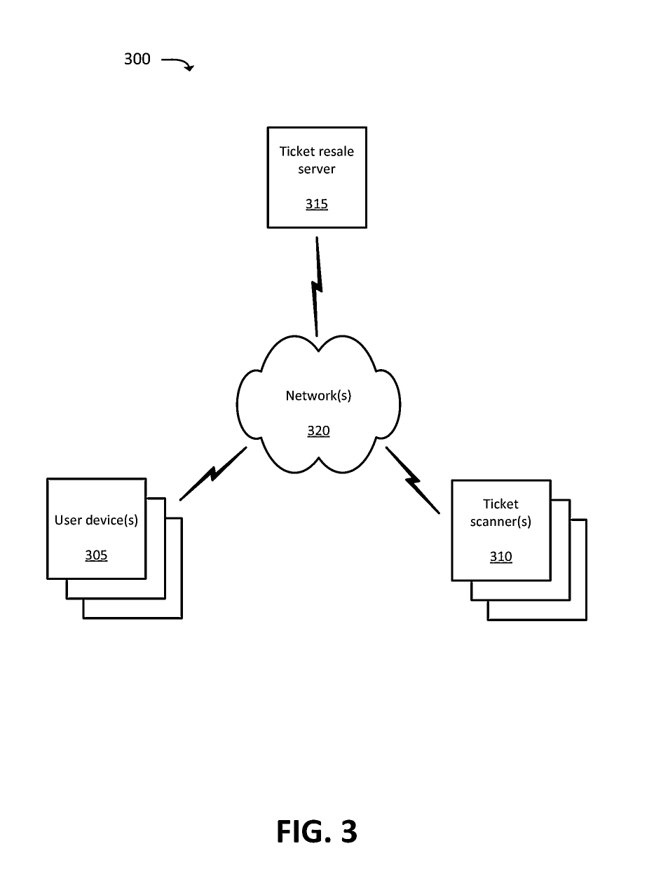

FIG. 3 illustrates an example environment 300, in which systems and/or methods described herein may be implemented. As shown in FIG. 3, environment 300 may include one or more user devices (hereinafter referred to collectively as “user devices 305,” or individually as “user device 305”), one or more ticket scanners (hereinafter referred to collectively as “ticket scanners 310,” or individually as “ticket scanner 310”), ticket resale server 315, and network 320. The quantity of devices and/or networks, illustrated in FIG. 3, is provided for explanatory purposes only. In practice, there may be additional devices and/or networks; fewer devices and/or networks; different devices and/or networks; or differently arranged devices and/or networks than illustrated in FIG. 3. Alternatively, or additionally, one or more of the devices of environment 300 may perform one or more functions described as being performed by another one or more of the devices of environment 300. Devices of environment 300 may interconnect via wired connections, wireless connections, or a combination of wired and wireless connections.

User device 305 may include any computation and communication device that is capable of directly or indirectly communicating with one or more networks, such as network 315. In some implementations, user device 305 may communicate with network 320 via one or more access networks, such as a radio access network (“RAN”). User device 305 may include, for example, a desktop computer, a laptop computer, a radiotelephone, a personal communications system (“PCS”) terminal (e.g., a device that combines a cellular radiotelephone with data processing and data communications capabilities), a personal digital assistant (“PDA”) (e.g., that can include a radiotelephone, a pager, Internet/intranet access, etc.), a smart phone, a tablet computer, a camera, a personal gaming system, or another type of computation and communication device.

Ticket scanner 310 may include a device that is capable of scanning tickets for entry to a venue. Ticket scanner 310 may communicate with one or more other devices via, for example a wired or wireless connection, and/or through network 320. In some implementations, ticket scanner 310 may be incorporated as part of, include, or may be communicatively coupled with, one or more user devices 305. In some implementations, ticket scanner 310 may be capable of outputting information regarding scanned tickets to, for example, ticket resale server 315 (e.g., via network 320).

Ticket resale server 315 may include any computation and communication device provides for the repurchase of previously purchased event tickets, as described in greater detail below. Ticket resale server 315 may communicate with one or more other devices (e.g., user device 305 and ticket scanner 310) via one or more networks (e.g., network 320).

Network 320 may include one or more wired and/or wireless networks, such as a RAN, a local area network (“LAN”), a wide area network (“WAN”—such as the Internet), or another type of network (e.g., another type of packet data network (“PDN”)). A RAN included in network 320 may, in some implementations, be associated with an evolved packet system (“EPS”) that includes a Long Term Evolution (“LTE”) network and/or an evolved packet core (“EPC”) network that operate based on a Third Generation Partnership Project (“3GPP”) wireless communication standard. The RAN may include one or more base stations, some or all of which may take the form of an evolved node B (“eNB”), via which user device 305 may communicate with the EPC network. The EPC network may include one or more serving gateways (“SGWs”), PDN gateways (“PGWs”), and/or mobility management entities (“MMEs”), and may enable user device 305 to communicate with other networks. User device 305, ticket scanner 310, and/or ticket resale server 315 may connect, through network 320, to other networks, data servers, application servers, or other servers/applications that are coupled to network 320.

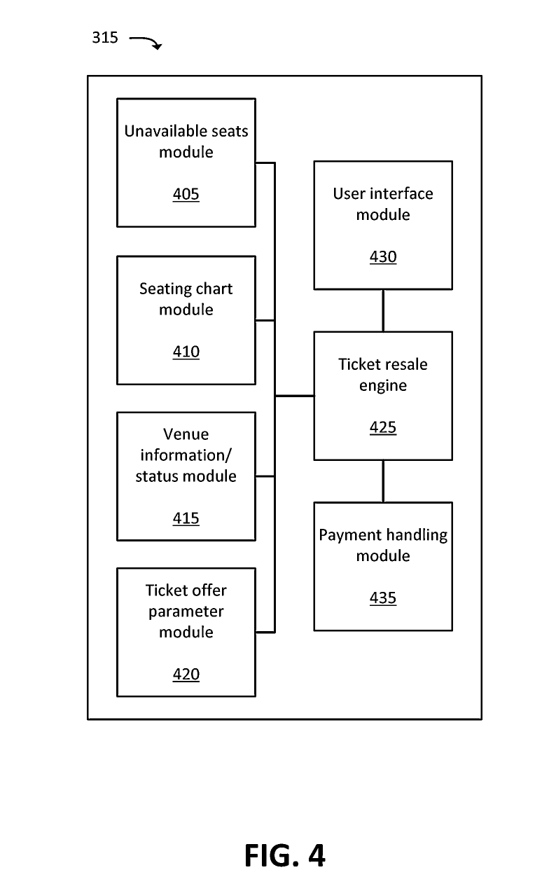

FIG. 4 illustrates example functional components of one or more of the devices shown in FIG. 3. For instance, FIG. 4 illustrates an example ticket resale server 315, which may include unavailable seats module 405, seating chart module 410, venue information/status module 415, ticket offer parameter module 420, ticket resale engine 425, user interface module 430, and payment handling module 435. Although ticket resale server 315 is shown as a single device in this figure, in practice, some of the functionality performed by ticket resale server 315 may be performed by multiple different devices. Furthermore, in some implementations, ticket resale server 315 may include additional, fewer, different, or differently arranged components. The components shown in FIG. 3 may each include circuitry and/or software that allow the components to perform the respective functions described below.

Unavailable seats module 405 may receive and/or store information regarding seats that are available and/or unavailable for a particular event or for a particular venue. For instance, unavailable seats module 405 may receive information from ticket scanners 310 when tickets are scanned. Unavailable seats module 405 may store an indication that scanned tickets are unavailable for the event that corresponds to the scanned tickets. As another example, unavailable seats module 405 may receive an indication from a particular user device 305 that tickets, associated with the user device, are unavailable for resale. For instance, a user associated with the user device may “check in” to the event, or may otherwise indicate a preference that the tickets not be resold. As another example, unavailable seats module 405 may receive information from, for example, an administrator (e.g., an organizer of an event or an administrator associated with the venue) that certain seats should not be made available for resale, even if they have not been occupied. For instance, a sports team may not desire to resell front row tickets, in the interest of maintaining high prices and desirability of such tickets. In some implementations, the information received and/or stored by unavailable seats module 405 may include information regarding seats that are available for resale, in addition to, or in lieu of, information regarding seats that are not available for resale.

Seating chart module 410 may receive and/or store information regarding a seating chart of a venue, a set of venues, and/or a set of events that are associated with a venue or set of venues. The seating chart information may include, for example, a visual representation (e.g., similar to the picture of the stadium shown in FIG. 1B). In some implementations, the seating chart information may additionally, or alternatively, include a textual representation (e.g., similar to the table shown in FIG. 1B) of the seating arrangement of the venue. Seating chart module 410 may receive this information from, for example, an organizer of an event at the venue, and/or from an administrator of the venue.

Seating chart module 410 may, in some implementations, store multiple different seating charts, that correspond to different events, and/or to different venues. For instance, in some situations, a seating chart for one event (e.g., a concert) at one venue may be different from a seating chart for a different event (e.g., a football game) at the same venue. In such situations, seating chart module 410 may store information indicating dates and/or times that certain seating charts are valid. In some implementations, seating chart module 410 may store a “default” seating chart for one or more venues, which may indicate a standard seating chart that should apply when other explicit exceptions do not apply.

Venue information/status module 415 may receive and/or store information regarding events that occur at venues. For example, the information received and/or stored by venue information/status module 415 may include dates and times that particular events occur at venues. For each event, venue information/status module 415 may receive and/or store information indicating a point at which tickets, which have been purchased but not used, should be offered for resale. Venue information/status module 415 may also receive information regarding real-time event status. For instance, venue information/status module 415 may receive real-time (or substantially real-time) information regarding how much time is left in a game, the score of a game, how many quarters are left in the game, etc. In some implementations, venue information/status module 415 may receive an indication (e.g., a manually provided indication from an administrator of a venue and/or from an organizer of an event) that tickets, which have been purchased but not used, should be sold.

Ticket offer parameter module 420 may receive and/or store pricing information for tickets that are offered for resale. Such pricing information may be received from, for example, an event organizer, an administrator of a venue, and/or from an original purchaser of a ticket. The pricing information may indicate that the price of a ticket is a flat value, a percent discount off of the original face value of the ticket, a percentage of the face value of the ticket, or some other price. The information may indicate different prices and/or pricing scheme for different tickets, or tiers of tickets. For example, front row tickets may be associated with a 10% discount, while other tickets may be associated with a 50% discount. In some implementations, the resale price of tickets may be set automatically by ticket offer parameter module 420 (or another device) based on factors, such as seat placement (e.g., row and section), quantity of seats together, a weighting factor that indicates how desirable the seats are, quantity of total available seats (in the same section as the seats and/or in the venue), and/or other factors.

Ticket resale engine 425 may aggregate information received from unavailable seats module 405, seating chart module 410, venue information/status module 415, and/or ticket offer parameter module 420 in order to resell tickets (e.g., tickets that have been purchased but not used) for an event. Ticket resale engine 425 may determine, based on information received from unavailable seats module 405 and/or seating chart module 410, which seats are unoccupied, occupied, sold, and/or unsold for an event. Ticket resale engine 425 may receive a request (e.g., via user interface module 430) for information regarding unoccupied, occupied, sold, and/or unsold seats. For instance, the request may correspond to a request made by a user who wishes to upgrade his or/her existing seats, or by a user who wishes to purchase new tickets to the event.

Based on information received from venue information/status module 415, ticket resale engine 425 may determine which, if any tickets, are available for sale. For instance, assume that the information from venue information/status module 415 indicates that tickets should not be resold before half time, which has not yet occurred by the time of the request. In this situation, ticket resale engine 425 may output information (e.g., to user interface module 430) indicating that tickets are not available for resale, and that tickets may be available at half time. Additionally, or alternatively, ticket resale engine 425 may output information regarding unsold, or “for sale,” tickets, which are available for sale. That is, these unsold tickets may never have been bought, and the “for sale” tickets may have been previously purchased, but explicitly offered for resale. For instance, a “for sale” ticket may be a ticket that a purchaser decides that he or she wishes to offer for resale. If, on the other hand, half time has occurred before the time of the request, ticket resale engine 425 may output information regarding tickets that have been sold, but are unused. Additionally, ticket resale engine 425 may also output information regarding unsold or “for sale” tickets.

In some implementations, the information outputted by ticket resale engine 425 may include a visual representation of seats, which correspond to tickets that are available for sale. For instance, the visual representation may be similar to graphical element 155 in FIG. 1B, with visual indicators similar to visual indicators 165, 170, and/or 175. In some implementations, the information outputted by ticket resale engine 425 may include a visual representation of the venue and non-visual information (e.g., similar to table 160 shown in FIG. 1B) regarding available seats. The information outputted by ticket resale engine 425 may also include pricing information, based on information received from ticket offer parameter module 420.

Ticket resale engine 425 may receive (e.g., via user interface module 430) an order for tickets that are offered for sale or resale. The order for tickets may include payment information (e.g., a credit card number, encrypted payment information, etc.). Ticket resale engine 425 may output the payment information to payment handling module 435, and may receive a response to indicate that payment was successfully received. Ticket resale engine 425 may also output information to payment handling module 435, indicating how the payment should be distributed (e.g., based on information received from ticket offer parameter module 420). For instance, ticket resale engine 425 may output information indicating a percentage that should go to the original purchaser, a percentage that should go to the venue, and/or a percentage that should go to the event organizer.

Ticket resale engine 425 may, in some implementations, update information stored in unavailable seats module 405 to reflect that the tickets were purchased, and the corresponding seats are no longer available. In some implementations, ticket resale engine 425 may update information stored in unavailable seats module 405 to reflect that the purchaser's previous seats are now available.

User interface module 430 may act as an interface between a prospective ticket purchaser's user device 305 and ticket resale engine 425. User interface module 430 may generate and/or output messages that notify the prospective ticket purchaser that seats are available (e.g., through an email message, a short message service (“SMS”) message, via an “app” running on user device 305, etc.). Additionally, or alternatively, user interface module 430 may generate and/or output graphical user interfaces (“GUIs”) that aid the prospective ticket purchaser in viewing, selecting seats, and purchasing the tickets. Further, user interface module 430 may generate and/or output ticket information, which may be used to enter the venue and/or to prove that the purchaser has purchased those seats.

Payment handling module 435 may receive payment information from ticket resale engine 425, and may serve to authorize and/or collect payment for tickets. Payment handling module 435 may include, or interface with, an e-commerce payment processing system in order to process payments. Payment handling module 435 may also distribute payments (e.g., to bank accounts, or to other types of accounts) based on information received from ticket resale engine 425 (e.g., identities of payment recipients, as well as how much to pay to each recipient).

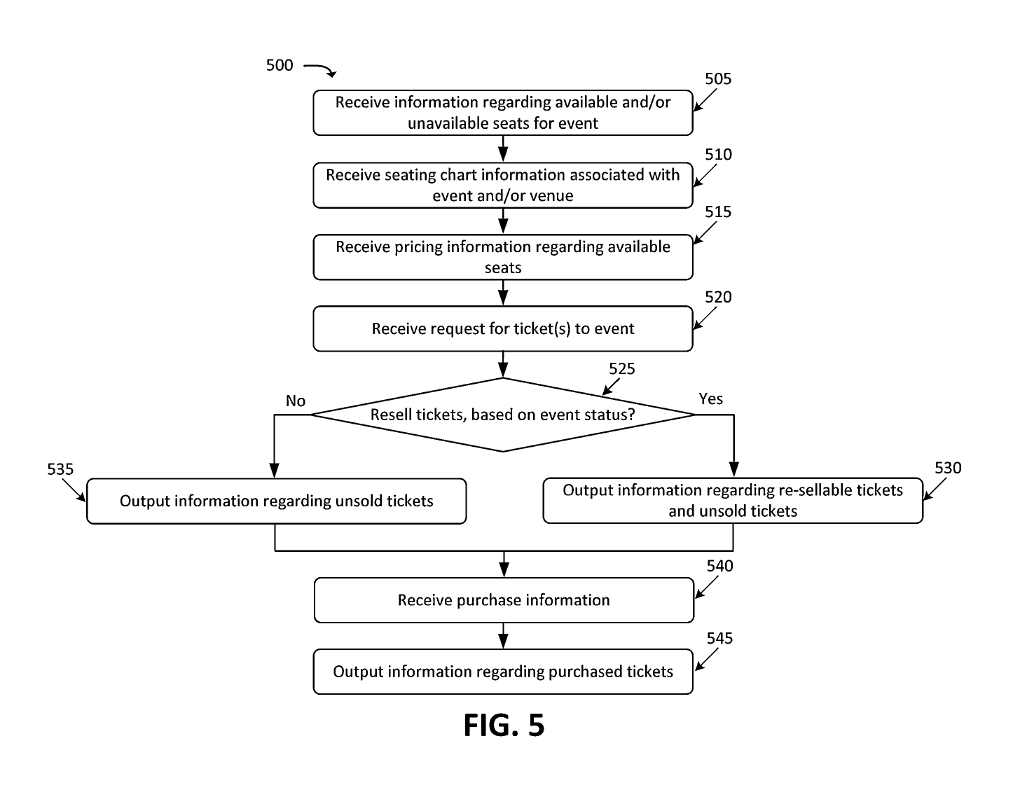

FIG. 5 illustrates an example process 500 for reselling unsold and/or unoccupied seats. In one example implementation, process 500 may be performed by ticket resale server 315. For example, some or all of process 500 may be performed by some or all of various modules described above with respect to FIG. 4. In other implementations, some or all of process 500 may be performed by one or more other devices in lieu of, or in conjunction with, ticket resale server 315.

Process 500 may include receiving information regarding available and/or unavailable seats for an event (block 505). For instance, as described above with respect to unavailable seats module 405, ticket resale server 315 may receive information from one or more ticket scanners 310 and/or user devices 305. The information may correspond to tickets that have been scanned, manual check-ins performed by users, indications that tickets should not be made available for resale, etc.

Process 500 may also include receiving seating chart information associated with the event and/or the venue at which the event is held (block 510). For example, as described above with respect to seating chart module 410, ticket resale server 315 may receive information regarding a seating chart regarding the particular event, and/or a default seating chart associated with the venue.

Process 500 may further include receiving pricing information regarding available seats (block 515). For example, as described above with respect to ticket offer parameter module 420, ticket resale server 315 may receive information regarding the cost of tickets that are sold or resold.

Process 500 may additionally include receiving a request for tickets to the event (block 520). For example, as described above with respect to ticket resale engine 425 and user interface module 430, ticket resale server 315 may receive a request from a user to upgrade existing tickets, and/or to purchase new tickets for the event.

Process 500 may also include determining whether to resell seats, which have been purchased but not occupied, based on the status of the event (block 525). For instance, as discussed above with respect to venue information/status module 415, ticket resale server 315 may determine whether a current status of the event indicates that tickets, which have been sold but are unused, should be resold.

If tickets can be resold based on the status of the event (block 525—YES), then process 500 may include outputting information regarding re-sellable tickets and unsold tickets (block 530). For example, as described above with respect to ticket resale engine 425 and user interface module 430, ticket resale server 315 may generate a visual representation, similar to the one shown in FIG. 1B. This visual representation may include indicators of seats that are available for sale (e.g., seats that have not been previously sold), as well as seats that are available for resale (e.g., seats that have been previously sold, but are unoccupied).

If, on the other hand, tickets should not be resold based on the status of the event (block 525—NO), then process 500 may include outputting information regarding unsold tickets (block 535). That is, this information may indicate that tickets, which have not been sold, are available, while tickets that have been previously purchased are not available. For example, as described above with respect to ticket resale engine 425 and user interface module 430, ticket resale server 315 may generate a visual representation, similar to the one shown in FIG. 1B, which may include indicators of seats that are available for sale (e.g., seats that have not been previously sold).

In some implementations, ticket resale server 315 may output information to user device 305, based on which user device 305 may generate a visual representation of available tickets. For example, ticket resale server 315 may output (at block 530 and/or at block 535) some or all of the information, received at blocks 505-520, to user device 305.

Process 500 may also include receiving purchase information (block 540). For example, as described above with respect to ticket resale engine 425, ticket resale server 315 may receive information regarding seats (e.g., based on information outputted at block 530 or block 535) that a user wishes to purchase. As described above with respect to payment handling module 435, ticket resale server 315 may process the purchase information and distribute the payment accordingly.

Process 500 may additionally include outputting information regarding the purchased seats (block 545). For example, as described above with respect to user interface module 430, ticket resale server 315 may output ticket and/or seat information. In some implementations, ticket resale server 315 may output this information via email, SMS message, and/or via an “app” running on user device 305.

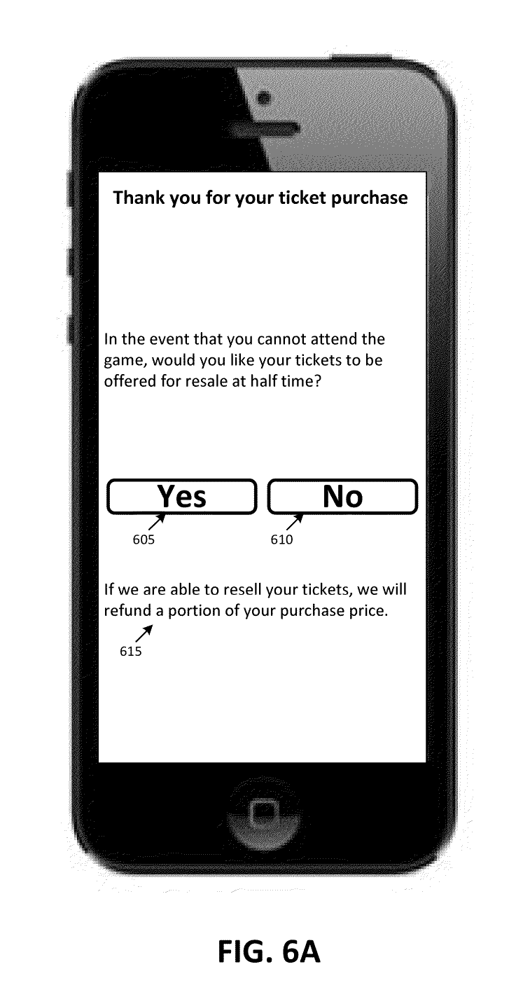

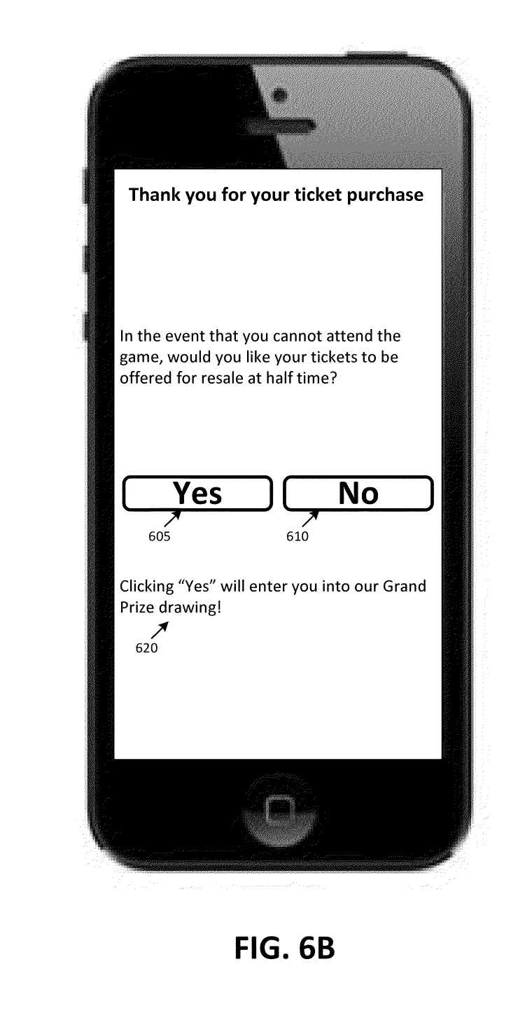

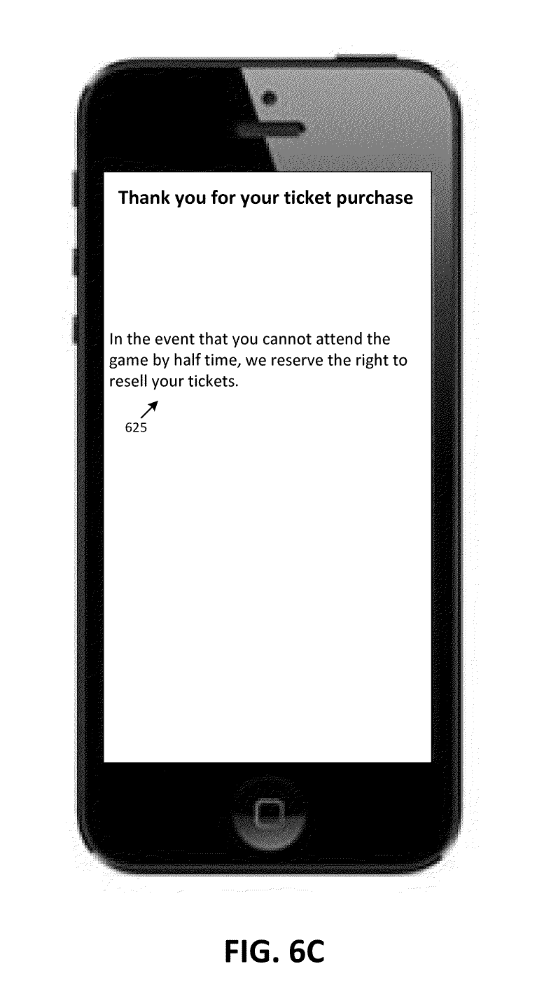

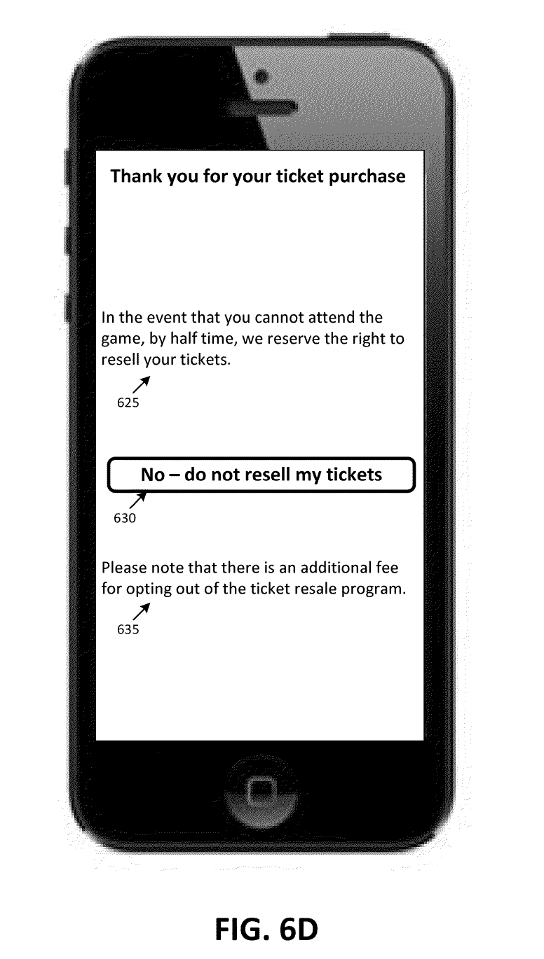

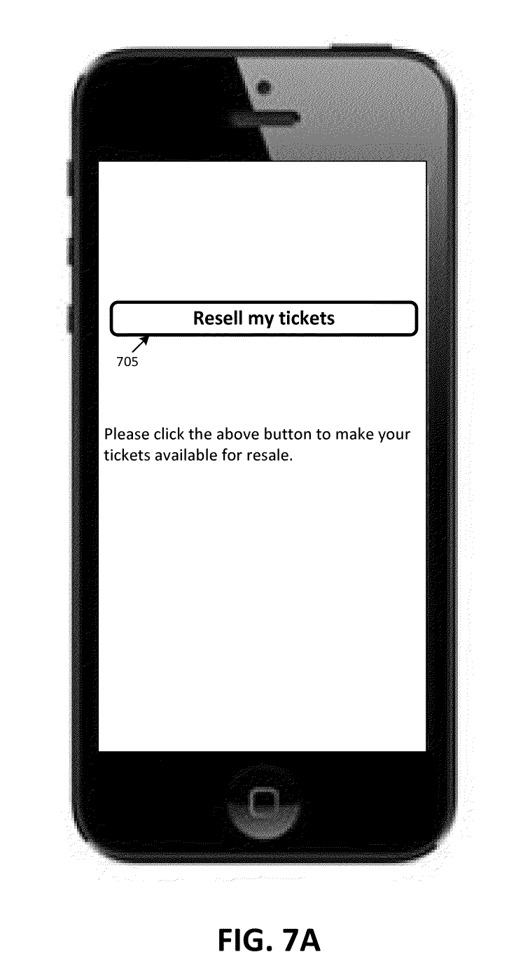

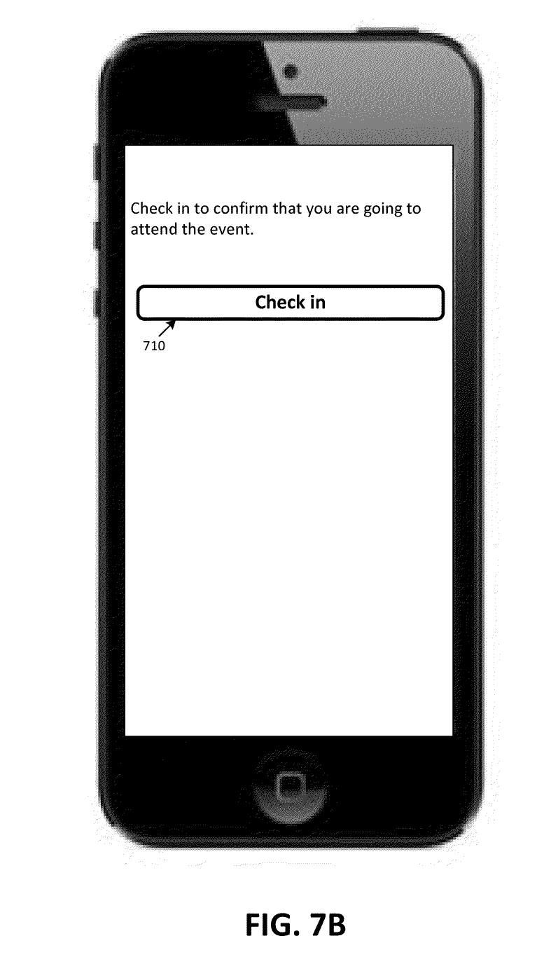

FIGS. 6A-6D, 7A, and 7B illustrate example user interfaces associated with registering tickets with a ticket resale program, in accordance with some implementations. FIGS. 6A-6D may be example user interfaces that may be displayed when a user purchases a ticket, and may correspond to opting in to a ticket resale program, opting out of the ticket resale program, or notifying the user that the tickets are subject to resale.

For instance, FIG. 6A illustrates an example user interface that corresponds to opting in or out of a ticket resale program. Upon purchase of tickets, the user may be asked if he or she would like to resell the tickets if the user has not arrived at the event by a certain time. Button 605 (“Yes”) may correspond to an option to opt in to the ticket resale program, while button 610 (“No”) may correspond to an option to opt out of the ticket resale program. Message 615 may inform the user that a portion of the proceeds from reselling the tickets may be refunded to the user.

FIG. 6B illustrates another example user interface that corresponds to opting in or out of a ticket resale program. This user interface may include similar options (e.g., buttons 605 and 610) as the one shown in FIG. 6A, but message 620 may notify the user that he or she may be entered into a drawing for a prize upon opting in to the ticket resale program.

FIG. 6C illustrates another example user interface that corresponds to notifying the user that if he or she does not use his or tickets by a certain point of the event, they may be resold. This user interface corresponds to an implementation in which a user cannot opt in or opt out of a ticket resale program.

FIG. 6D illustrates an example user interface that corresponds to an implementation in which a user is charged a fee for opting out of a ticket resale program. As shown, message 625 may indicate that the tickets will be resold if they are unused by a certain point. Button 630 may correspond to an option to opt out of the ticket resale program, and message 635 may notify the user that there is an additional fee for opting out of the ticket resale program.

FIG. 7A illustrates an example user interface that corresponds to an implementation in which a user may explicitly make his or her tickets available for resale. For example, button 705 may correspond to an option for the user to indicate that his or her tickets are available for resale. Such a situation may occur when the user knows he or she will be unable to attend the event. In some implementations, when this option (or a similar option) is selected, the tickets may be offered for resale before the designated event status has occurred (e.g., before half time of a sports game).

FIG. 7B illustrates an example user interface that corresponds to an implementation in which a user may “check in,” thus designating that his or her tickets should not be made available for resale. As shown, button 710 may be provided, upon which selection may indicate that corresponding tickets should not be made available for resale. In some implementations, button 710 may not be available until within a predetermined time (e.g., within 24 hours of the event, within 4 hours of the event, etc.).

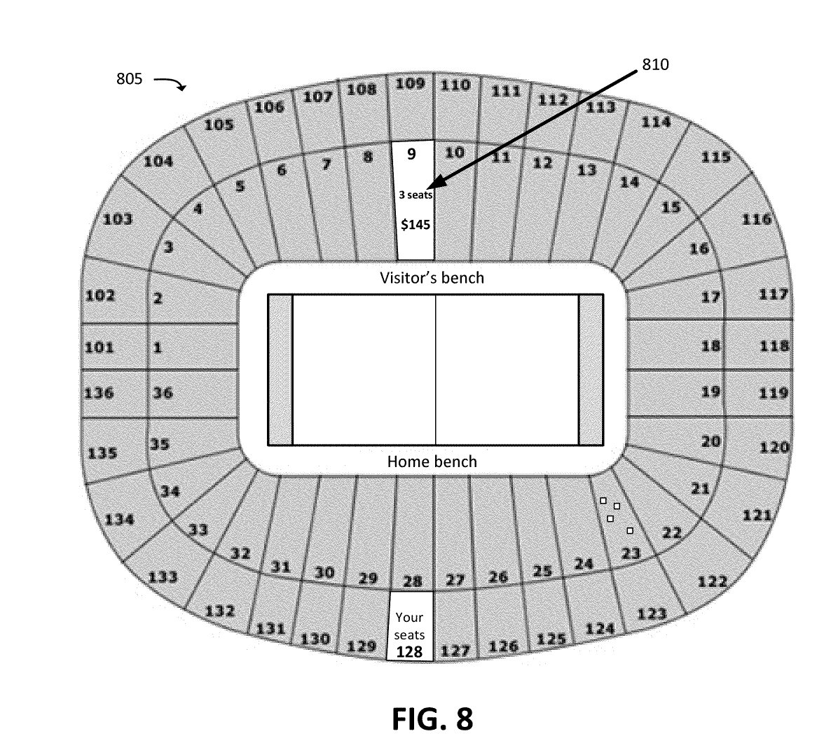

FIG. 8 illustrates an example user interface that may be presented to a prospective purchaser of unsold and/or unoccupied seats. For example, graphical element 805 may be similar to graphical element 155, shown in FIG. 1B, except graphical element 805 may include additional information, as compared to graphical element 155. For instance, information 810, such as a quantity of seats available in a section and/or price (or price range) per seat, may be shown (e.g., interposed on the corresponding section). Graphical element 805 may be displayed, for example, when a user is selecting seats for purchase or upgrade.

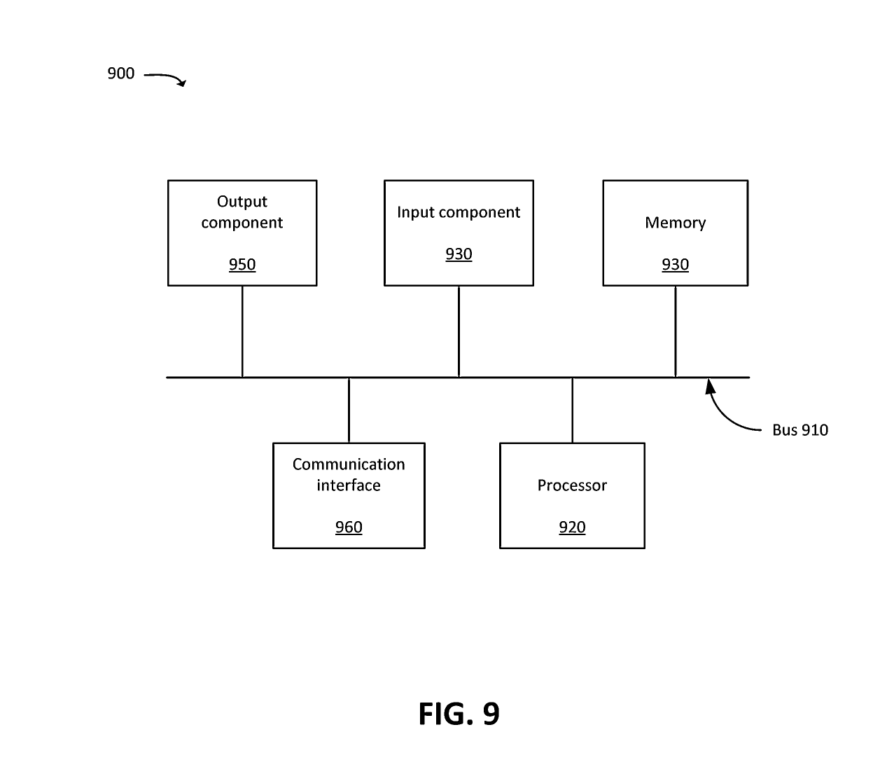

FIG. 9 is a diagram of example components of device 900. One or more of the devices described above may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while a series of blocks has been described with regard to FIG. 5, the order of the blocks may be modified in other implementations. Further, non-dependent blocks may be performed in parallel.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items, and may be used interchangeably with the phrase “one or more.” Where only one item is intended, the term “one” or similar language is used. Further, the phrase “based on” is intended to mean “based, at least in part, on” unless explicitly stated otherwise.

What is claimed is:

1. A method, comprising:
receiving, by a server device, use information regarding one or more tickets, to an event, that have been previously purchased, the use information indicating whether the one or more tickets have been used;
determining, by the server device and based on the use information, that the one or more tickets have not been used;
determining, by the server device, based on a status of the event, and further based on determining that the one or more tickets have not been used, that the one or more tickets should be offered for resale; and
offering, by the server device and based on the determining, the one or more tickets for resale.

2. The method of claim 1, further comprising:
receiving a request to purchase the one or more tickets that have been offered for resale;
receiving a payment, associated with the request, for the one or more tickets;
outputting, based on the request and the payment, a visual representation of the one or more tickets that have been offered for resale; and
providing at least a portion of the payment to an original purchaser of the one or more tickets.

3. The method of claim 1, further comprising:
receiving scanner information from one or more ticket scanner devices regarding tickets that have been scanned for entry to the event,
wherein the use information indicating whether the one or more tickets have been used is based on the scanner information received from the one or more ticket scanner devices.

4. The method of claim 3, wherein the scanner information received from the one or more ticket scanner devices does not indicate that the one or more tickets have been scanned for entry to the event.

5. The method of claim 1, further comprising:
receiving information regarding a cutoff time, the cutoff time indicating a previously determined elapsed or remaining portion of the event; and
receiving status information regarding the status of the event, the status information indicating an actual elapsed or remaining portion of the event,
wherein determining, based on the status of the event, that the one or more tickets should be offered for resale includes at least one of:
determining that the actual elapsed portion is greater than the previously determined elapsed portion, or
determining that the actual remaining portion is less than the previously determined remaining portion.

6. The method of claim 5, wherein a particular portion, of the elapsed or remaining portions of the event, correspond to at least one of a quarter, a third, or a half of the event.

7. The method of claim 5, wherein a particular portion, of the elapsed or remaining portions of the event, correspond to a duration of time.

8. The method of claim 1, further comprising:
receiving seating chart information associated with the event; and
generating, based on the seating chart information, a visual representation of tickets that are available for purchase,
wherein the visual representation indicates that the one or more tickets, that have been previously purchased and have not been used, are available for purchase,
wherein offering the one or more tickets for resale includes outputting the visual representation.

9. A server device, comprising:
a memory device storing a set of computer-executable instructions; and
one or more processors configured to execute the computer-executable instructions, wherein executing the computer-executable instructions causes the one or more processors to:
receive information regarding one or more tickets to an event, the information indicating that the one or more tickets have been previously purchased, the information further indicating that the one or more tickets have not been used;
determine, based on a status of the event, and further based on the information indicating that the one or more tickets have been previously purchased and have not been used, that the one or more tickets should be offered for resale; and
offer, based on the determining, the one or more tickets for resale.

10. The server device of claim 9, wherein executing the computer-executable instructions further causes the one or more processors to:
receive a request to purchase the one or more tickets that have been offered for resale;
receive a payment, associated with the request, for the one or more tickets;
output, based on the request and the payment, a visual representation of the one or more tickets that have been offered for resale; and
provide at least a portion of the payment to an original purchaser of the one or more tickets.

11. The server device of claim 9, wherein executing the computer-executable instructions further causes the one or more processors to:
receive information from one or more ticket scanner devices regarding tickets that have been scanned for entry to the event,
wherein the information indicating that the one or more tickets have not been used is based on the information received from the one or more ticket scanner devices.

12. The server device of claim 11, wherein the information received from the one or more ticket scanner devices indicates that the one or more tickets have not been scanned for entry to the event.

13. The server device of claim 9, wherein executing the computer-executable instructions further causes the one or more processors to:
receive information regarding a cutoff time, the cutoff time indicating a previously determined elapsed or remaining portion of the event; and
receive status information regarding the status of the event, the status information indicating an actual elapsed or remaining portion of the event,
wherein executing the computer-executable instructions to determine that the one or more tickets should be offered for resale, further causes the one or more processors to:
determine that the actual elapsed portion is greater than the previously determined elapsed portion, or
determine that the actual remaining portion is less than the previously determined remaining portion.

14. The server device of claim 9, wherein executing the computer-executable instructions further causes the one or more processors to:
receive seating chart information associated with the event; and
generate, based on the seating chart information, a visual representation of seats for which tickets are available for purchase,
wherein the visual representation indicates that one or more tickets for the one or more seats, that have been previously purchased and have not been used, are available for purchase.

15. A computer-readable medium, comprising:
a plurality of computer-executable instructions stored thereon, which when executed by one or more processors of a server device, cause the one or more processors to:
receive scanner information from a set of ticket scanner devices that scan tickets for entry to an event, the scanner information indicating a first plurality of tickets that have been scanned by the set of ticket scanner devices;
identify, after at least a threshold duration of time after the start of the event and based on the received scanner information, a second plurality of tickets to the event that have been purchased but not used; and
offer, based on the identifying, the one or more tickets, of the second plurality of tickets, for resale.

16. The computer-readable medium of claim 15, wherein when executed, the computer-executable instructions further cause the one or more processors to:
receive a request to purchase the one or more tickets that have been offered for resale;
receive a payment, associated with the request, for the one or more tickets; and
provide at least a portion of the payment to an original purchaser of the one or more tickets.

17. The computer-readable medium of claim 15, wherein when executed, the computer-executable instructions to identify the second plurality of tickets further cause the one or more processors to:
identify tickets that have been purchased, but for which scanner information, indicating that the tickets have been used, has not been received.

18. The computer-readable medium of claim 15, wherein the scanner information received from the one or more ticket scanner devices:
indicates that the one or more tickets have not been scanned for entry to the event, or
does not indicate that the one or more tickets have been scanned for entry to the event.

19. The computer-readable medium of claim 15, wherein when executed, the computer-executable instructions further cause the one or more processors to:
receive check-in information from a user device, the check-in information indicating being associated with at least one ticket to the event;
identify that the at least one ticket has been used,
wherein when executed, the computer-executable instructions to offer the one or more tickets for resale further cause the one or more processors to forgo offering the at least one ticket for sale.

20. The computer-readable medium of claim 15, wherein when executed, the computer-executable instructions further cause the one or more processors to:
output seating chart information associated with the event, the seating chart information being usable to generate a visual representation of seats for which tickets are available for purchase.
